(19) United States
(12) Patent Application Publication
(10) Pub. No.: US 2025/0299896 A1
(43) Pub. Date: Sep. 25, 2025

(54) HEAT DISSIPATION DEVICE FOR HIGH-CURRENT VACUUM INTERRUPTER AND MANUFACTURING METHOD THEREFOR

(71) Applicant: XI'AN JIAOTONG UNIVERSITY, Xi'an (CN)

(72) Inventors: Fei YANG, Xi'an (CN); Zhaowei DIAO, Xi'an (CN); Mingzhe RONG, Xi'an (CN); Jinru SUN, Xi'an (CN); Haichen LI, Xi'an (CN); Hongbin CHEN, Xi'an (CN); Xiangyu HAN, Xi'an (CN); Qiong KANG, Xi'an (CN); Yifei WU, Xi'an (CN); Yi WU, Xi'an (CN)

(21) Appl. No.: 19/086,887

(22) Filed: Mar. 21, 2025

(30) Foreign Application Priority Data
Mar. 22, 2024 (CN) 2024103336357

(51) Int. Cl. H01H 33/66

(52) U.S. Cl. CPC H01H 33/6606; H01H 2033/6613

(57) ABSTRACT

Disclosed in the present disclosure are a heat dissipation device for a high-current vacuum interrupter and a manufacturing method therefor. The heat dissipation device includes a mobile-end heat dissipation structure and a stationary-end heat dissipation structure which are disposed at two ends of the vacuum interrupter, and the heat dissipation device is manufactured by a method of combining additive manufacturing with subtractive manufacturing. The heat dissipation device is high in precision and high in machining efficiency, and the structure of the heat dissipation device can be flexibly designed according to actual needs, significantly reducing the production cost of the heat dissipation device, which is of great significance in practice.

### CROSS-REFERENCE TO RELATED APPLICATION

This application claims priority from the Chinese patent application 2024103336357 filed Mar. 22, 2024, the content of which is incorporated herein in the entirety by reference.

### TECHNICAL FIELD

The present disclosure belongs to the field of metal processing and manufacturing, particularly belongs to the technical field of vacuum interrupters, and relates to a heat dissipation device suitable for a high-current vacuum interrupter and a manufacturing method therefor.

### BACKGROUND

With the continuous development of modern power systems, voltage levels continue to rise and system capacities continue to increase, and the need for large-capacity generator sets increases. The increasing generator capacity will cause a significant increase in short-circuit fault current, and the conventional circuit breakers cannot meet the breaking requirements. Therefore, it is necessary to install a generator circuit breaker to protect a generator and a power system. The generator circuit breaker is installed between terminals of the generator and a transformer, can effectively break the short-circuit fault current of a generator source and a system source, and has the advantages of reducing the fault range of the generator and the transformer, improving the reliability and flexibility of power consumption in a plant, simplifying the operation process, satisfying the requirements of frequent start and stop of the sets, and ensuring safe and stable operation of the power system.

Compared with ordinary circuit breakers, the generator circuit breaker faces more extreme operating conditions, including huge short-circuit current breaking and electric power, temperature rise caused by a high rated current, direct current breaking, and a high transient voltage rise rate. At present, the most widely used generator circuit breaker is an SF6 circuit breaker, which has better breaking capability, better insulation performance and larger capacity. However, SF6 is an extremely strong greenhouse gas with a greenhouse effect of 24,900 times that of CO2, which will produce an extremely strong temperature rise effect. Under the dual carbon goals of carbon peaking and carbon neutrality, the use of the SF6 circuit breaker must be limited and optimized.

A vacuum circuit breaker uses a vacuum interrupter as an arc extinguishing structure, and has the advantages of no greenhouse gas emission, environmental protection, low cost, convenient maintenance, more short-circuit breaking times and long life compared with the SF6 circuit breaker. Excessive temperature rise is a bottleneck problem that restricts the development and application of the vacuum circuit breaker, and an excessively high temperature easily causes problems of reduced mechanical strength of the circuit breaker, deterioration of insulation, etc., and limits the miniaturization development of the vacuum circuit breaker. A main heat generation source of the vacuum circuit breaker comes from the vacuum interrupter, larger circuit resistance causes higher heat generation, and therefore, additional heat dissipation structures need to be added at both ends of the vacuum interrupter, increasing the heat dissipation capacity by increasing a heat dissipation area, reducing the temperature rise of the circuit breaker.

The conventional heat dissipation structure adopts a machining manner, and cutting subtractive manufacturing is performed on a complete copper alloy block. A material utilization rate is low, a production cost is high, and a period is long, and at the same time, due to the limitations of the machining manner, the heat dissipation structure cannot be freely optimized and designed, and the heat dissipation capacity cannot be fully utilized.

Therefore, how to reduce the production cost, improve the material utilization rate and reduce the processing cycle on the basis of improving the heat dissipation capacity of the heat dissipation structure is an urgent technical problem to be solved.

### SUMMARY

To solve the above problems, the inventors conducted intensive research and developed a heat dissipation device suitable for a high-current vacuum interrupter and a manufacturing method therefor. The heat dissipation device includes a mobile-end heat dissipation structure and a stationary-end heat dissipation structure which are disposed at two ends of the vacuum interrupter, and the heat dissipation device is manufactured by a method of combining additive manufacturing with subtractive manufacturing. Specifically, by establishing a structural model of the heat dissipation device, performing simulation iterative optimization on the structural model, and sequentially performing subtractive manufacturing and additive manufacturing on a base material according to the optimized structural model; and processing components such as screw holes according to the installation requirements between the heat dissipation device and the vacuum interrupter, the manufactured heat dissipation device is high in precision and high in machining efficiency, and heat dissipation fins are high in heat dissipating efficiency, which is of great significance in practice, thus completing the present disclosure.

In particular, an object of the present disclosure is to provide the following aspects:

in a first aspect, provided is a heat dissipation device for a vacuum interrupter, including a mobile-end heat dissipation structure and a stationary-end heat dissipation structure which are disposed at two ends of the vacuum interrupter, wherein the heat dissipation device is manufactured by a method of combining additive manufacturing with subtractive manufacturing.

In a second aspect, provided is a method for manufacturing the heat dissipation device in the first aspect, including:
Step 1, establishing a structural model of the heat dissipation device;
Step 2, generating a machining procedure from dimensional information of the structural model; and
Step 3, sequentially performing subtractive manufacturing and additive manufacturing on a base material according to the machining procedure to manufacture the heat dissipation device.

In a third aspect, provided is a vacuum interrupter, including the heat dissipation device in the first aspect.

The beneficial effects of the present disclosure include:

(1) The heat dissipation device suitable for a high-current vacuum interrupter provided by the present disclosure is manufactured by the method of combining additive manufacturing with subtractive manufacturing, and flexible design of the structure of the heat dissipation device is achieved according to actual needs, significantly reducing the production cost of the heat dissipation device and improving the production and processing efficiency.

(2) The heat dissipation device suitable for a high-current vacuum interrupter provided by the present disclosure mainly includes the conductive connection structures and the heat dissipation fins, wherein subtractive manufacturing is adopted for the conductive connection structures, that is, cutting machining is performed on the base material, and then additive manufacturing is performed on the surfaces of the conductive connection structures, and layer-by-layer deposition is performed; and through the additive-subtractive composite manufacturing, the material utilization rate can be greatly improved and the production cost can be reduced on the basis of ensuring the manufacturing quality, and at the same time, the heat dissipation fins are freely designed to fully exert the heat dissipation effect.

(3) According to the method for manufacturing the heat dissipation device suitable for a high-current vacuum interrupter provided by the present disclosure, by establishing the structural model of the heat dissipation device, iteratively optimizing processing parameters of the structural model through simulation, and using additive-subtractive composite manufacturing, a final structure of the heat dissipation device for a vacuum interrupter is obtained, the processing precision is high, the process is mature, the production cost is effectively reduced, and the processing efficiency is improved.

### BRIEF DESCRIPTION OF DRAWINGS

Various additional advantages and benefits of the present disclosure will become apparent to those of ordinary skill in the art upon reading the following detailed description of the preferred embodiments. The drawings are only for the purpose of illustrating preferred embodiments and are not to be considered to be limiting of the present disclosure. Obviously, the drawings described below are merely some embodiments of the present disclosure, and for those of ordinary skill in the art, other drawings can also be obtained according to these drawings without paying inventive step.

In the drawings:

FIG. 1A shows a schematic structural diagram of a vacuum interrupter and a heat dissipation device thereof according to a preferred embodiment of the present disclosure;

FIG. 1B shows a front view of the structure of a vacuum interrupter and a heat dissipation device thereof according to a preferred embodiment of the present disclosure;

FIG. 2 shows a schematic structural diagram of a vacuum interrupter according to a preferred embodiment of the present disclosure;

FIG. 3A shows a schematic diagram of a mobile-end heat dissipation structure according to a preferred embodiment of the present disclosure;

FIG. 3B shows a schematic diagram of a mobile-end heat dissipation structure according to a preferred embodiment of the present disclosure;

FIG. 4A shows a schematic diagram of a stationary-end heat dissipation structure according to a preferred embodiment of the present disclosure;

FIG. 4B shows a schematic diagram of a stationary-end heat dissipation structure according to a preferred embodiment of the present disclosure; and

FIG. 5 shows a schematic plan view of proximal and distal path planning of a mobile-end heat dissipation fin according to a preferred embodiment of the present disclosure;

### REFERENCE NUMERALS

1—mobile-end heat dissipation structure;
2—stationary-end heat dissipation structure;
3—mobile-end conductive connection structure;
4—stationary-end conductive connection structure;
5—mobile-end heat dissipation fin;
6—stationary-end heat dissipation fin;
7—mobile end of vacuum interrupter;
8—stationary end of vacuum interrupter;
9—main shield
10—moving conductive rod;
11—stationary-end conductive block;
12—screw hole;
13—first boss;
14—first pit;
15—central hole;
16—proximal region of heat dissipation fin;
17—distal region of heat dissipation fin;
18—second boss; and
19—second pit.

### DETAILED DESCRIPTION OF THE INVENTION

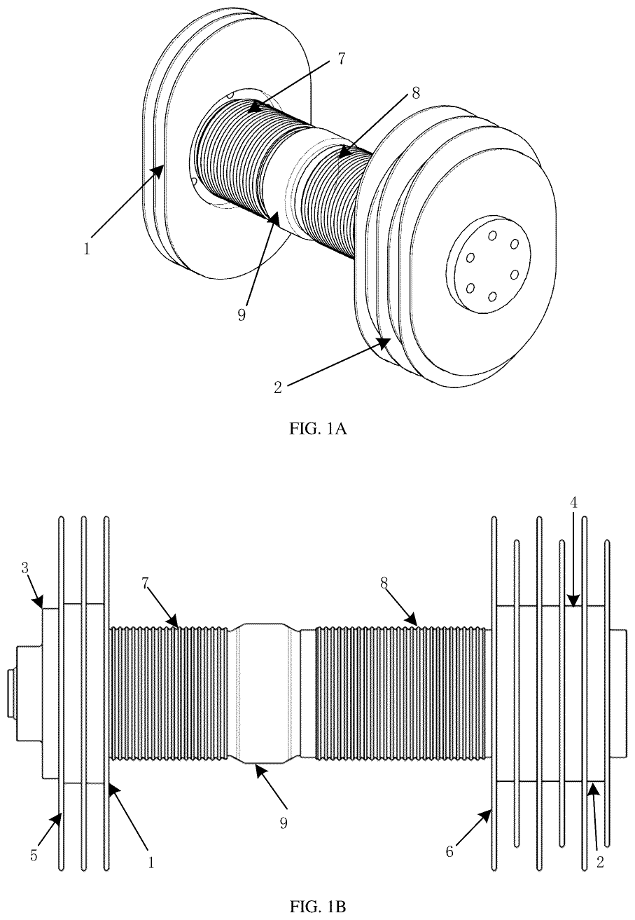

Specific embodiments of the present disclosure will be described in more detail below with reference to FIGS. 1 (A) to 5. Although specific embodiments of the present disclosure are illustrated in the accompanying drawings, it should be understood that the present disclosure may be embodied in various forms and should not be limited by the embodiments set forth herein. Rather, these embodiments are provided in order to enable a more thorough understanding of the present disclosure and to fully convey the scope of the present disclosure to those skilled in the art.

It should be noted that certain terms are used throughout the description and claims to refer to certain components. It will be appreciated by those skilled in the art that different terms may be used by those skilled to refer to the same component. The description and claims do not use differences in terms as a means of distinguishing components, but use differences in functions of components as a criterion for distinguishing. “Comprising” or “including” mentioned throughout the description and claims is an open-ended term, and thus, should be interpreted as “including, but not limited to.” The following description in the specification is to describe preferred embodiments for carrying out the present disclosure, but the description is for the purpose of general principles of the specification and is not intended to limit the scope of the present disclosure. The protection scope of the present disclosure is defined by the appended claims.

In the description of the present disclosure, it should be noted that an orientation or positional relationship indicated by the terms such as “upper”, “lower”, “inner”, “outer”, “front”, and “rear” is based on an orientation or positional relationship in the operational state of the present disclosure, only for ease of description of the present disclosure and simplicity of description, not indicating or implying that the device or element referred to must have a particular orientation, be constructed and operate in a particular orientation, and therefore should not be construed as limiting the present disclosure. Moreover, the terms “first”, “second”, “third”, and “fourth” are used for descriptive purposes only and are not to be construed as indicating or implying relative importance.

In order to facilitate an understanding of embodiments of the present disclosure, further explanation will be made below by taking specific embodiments as examples with reference to the accompanying drawings, and the accompanying drawings are not to be construed as limiting embodiments of the present disclosure.

Because a high current of tens of kiloamperes to hundreds of kiloamperes passes through an environmentally friendly large-capacity generator circuit breaker, and a vacuum interrupter has a certain current passing resistance, a serious temperature rise problem will be caused during operation, which affects the normal use of a vacuum circuit breaker, and in order to effectively suppress the temperature rise of the vacuum circuit breaker, it is necessary to add separate heat dissipation structures at a stationary end and a mobile end of a vacuum interrupter. The conventional heat dissipation structure uses a machining manner to directly perform cutting machining on a large-sized raw piece, a material utilization rate is low, a cost is high, and a machining period is long. At the same time, due to the limitation of machining equipment, the heat dissipation structures cannot be freely designed, so the heat dissipation capacity of the heat dissipation structures cannot be fully exerted.

Based on this, in one aspect, the present disclosure provides a heat dissipation device suitable for a vacuum interrupter, the heat dissipation device being manufactured by a method of combining additive manufacturing with subtractive manufacturing.

In the present disclosure, as shown in FIG. 1A and FIG. 1B, the heat dissipation device includes a mobile-end heat dissipation structure 1 and a stationary-end heat dissipation structure 2 which are disposed at two ends of the vacuum interrupter.

Further, a length of the stationary-end heat dissipation structure 2 is longer than that of the mobile-end heat dissipation structure 1, preferably, the length of the stationary-end heat dissipation structure 2 is 1.5-3 times, preferably 1.5 times, the length of the mobile-end heat dissipation structure 1; and the length of the stationary-end heat dissipation structure 2 is 100-200 mm, preferably 140-160 mm, for example 150 mm.

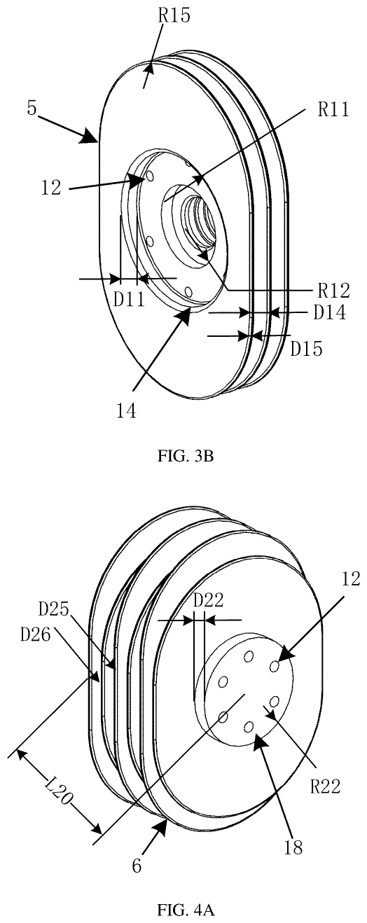

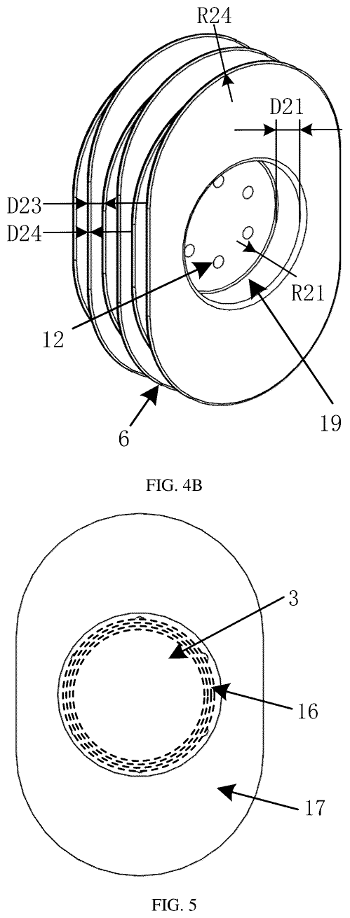

According to the present disclosure, as shown in FIG. 1B, FIG. 3A and FIG. 3B, the mobile-end heat dissipation structure 1 includes a mobile-end conductive connection structure 3 and mobile-end heat dissipation fins 5, wherein the mobile-end conductive connection structure 3 is obtained on a base material by subtractive manufacturing, and the mobile-end heat dissipation fins 5 are obtained on a surface of the mobile-end conductive connection structure 3 by additive manufacturing; and as shown in FIG. 1B, FIG. 4A and FIG. 4B, the stationary-end heat dissipation structure 2 includes a stationary-end conductive connection structure 4 and stationary-end heat dissipation fins 6, wherein the stationary-end conductive connection structure 4 is obtained on a base material by subtractive manufacturing and the stationary-end heat dissipation fins 6 are obtained on a surface of the stationary-end conductive connection structure 4 by additive manufacturing.

In the present disclosure, the mobile-end conductive connection structure 3 and the stationary-end conductive connection structure 4 can be machined in any shape, e.g., a square shape, a circular shape, or a prismatic shape, the shapes of the mobile-end conductive connection structure 3 and the stationary-end conductive connection structure 4 may be the same or different, and are both preferably in the circular shape which is easy to machine, and by taking the circular shape as an example, a diameter of the mobile-end conductive connection structure 3 is usually 3-4 times a diameter of a moving conductive rod 10, and a diameter of the stationary-end conductive connection structure 4 is preferably the same as the diameter of the mobile-end conductive connection structure 3, which is convenient for processing and size setting.

In the present disclosure, the heat dissipation fins, i.e., the mobile-end heat dissipation fins 5 and the stationary-end heat dissipation fins 6, are used to reduce the temperature rise caused by current passing by using air convection and radiation, realizing heat dissipation.

Further, the heat dissipation fins, i.e., the mobile-end heat dissipation fins 5 and the stationary-end heat dissipation fins 6, have excellent heat dissipation properties, and metals such as iron, copper, aluminum, tin, nickel, gold, silver and zinc among metals have excellent heat conduction characteristics, which can satisfy the actual demands of heat dissipation of the heat dissipation fins. Copper is second only to gold and silver in thermal conductivity, and also has the characteristics of corrosion resistance, wear resistance, and good plasticity, making it particularly outstanding as a thermally conductive metal, so copper is preferred as a material for the heat dissipation fins.

Further, one end of the mobile-end conductive connection structure 3 is connected with the moving conductive rod 10 at a mobile end 7 of the vacuum interrupter, and the other end of the mobile-end conductive connection structure 3 is connected with a flange; and one end of the stationary-end conductive connection structure 4 is connected with a stationary-end conductive block 11 at a stationary end 8 of the vacuum interrupter, and the other end of the stationary-end conductive connection structure 4 is connected with another flange.

According to the present disclosure, the mobile-end heat dissipation fins 5 are repeatedly arranged on the surface of the mobile-end conductive connection structure 3 and perpendicular to a cross section of the mobile-end conductive connection structure 3; and the stationary-end heat dissipation fins 6 are repeatedly arranged on the surface of the stationary-end conductive connection structure 4 and perpendicular to a cross section of the stationary-end conductive connection structure 4.

According to the present disclosure, a distance between the stationary-end heat dissipation fins 6 is 10-30 mm, and a distance between the mobile-end heat dissipation fins 5 is preferably consistent with the distance between the stationary-end heat dissipation fins 6.

Since the stationary-end heat dissipation structure 2 is longer, the number of the stationary-end heat dissipation fins 6 obtained by additive manufacturing on the surface of the stationary-end heat dissipation structure 2 will also be greater. As the length of the stationary-end heat dissipation structure 2 increases (also understood as the number of the stationary-end heat dissipation fins 6 is greater), the heat dissipating effect is better; however, an excessively long stationary-end heat dissipation structure 2 (also understood as an excessive number of the stationary-end heat dissipation fins 6) leads to an increase in cost on one hand, and more importantly, leads to an excessive volume, affecting the installation of the vacuum interrupter and its related heat dissipation structures in the overall space of the circuit breaker.

According to the present disclosure, in general, the number of the stationary-end heat dissipation fins 6 is 3-10, preferably 5-7, for example, 6; and the number of the mobile-end heat dissipation fins 5 is 1-5, preferably 2-4, for example, 3.

According to the present disclosure, a thickness of the stationary-end heat dissipation fins 6 is preferably consistent with a thickness of the mobile-end heat dissipation fins 5, and the thickness is typically 3-10 mm, preferably 4-6 mm, for example, 5 mm.

The excessive thickness causes the overall volume of the mobile-end heat dissipation structure 1 and the stationary-end heat dissipation structure 2 to increase, and affects the convection effect between the mobile-end heat dissipation fins 5 and the stationary-end heat dissipation fins 6 and air; and if the thickness is too small, the difficulty of processing the structure will be increased, and the thickness is generally most suitable within the above parameter range.

According to the present disclosure, the heat dissipation fins, i.e., the mobile-end heat dissipation fins 5 and the stationary-end heat dissipation fins 6, may be of a regular shape such as an ellipse, a circle, and a square, or may be of an irregular shape.

According to the present disclosure, the structure of the mobile-end heat dissipation fins 5 and the structure of the stationary-end heat dissipation fins 6 have flexibility, in particular: the mobile-end heat dissipation fins 5 and the stationary-end heat dissipation fins 6 may be consistent or inconsistent in shape; of course, the shape and size of each of the mobile-end heat dissipation fins 5 may be consistent or inconsistent; and the shape and size of each of the stationary-end heat dissipation fins 6 may be consistent or inconsistent.

In one embodiment, the mobile-end heat dissipation structure 1 is shown in FIG. 3A and FIG. 3B, the mobile-end heat dissipation structure 1 includes 3 mobile-end heat dissipation fins 5 in total, the shape and size of the mobile-end heat dissipation fins 5 are consistent, and each mobile-end heat dissipation fin 5 is in the shape of an annular runway.

In an embodiment, the stationary-end heat dissipation structure 2 is shown in FIG. 4A and FIG. 4B, the stationary-end heat dissipation structure 2 includes 6 stationary-end heat dissipation fins 6 in total, the stationary-end heat dissipation fins 6 are all in the shape of an annular runway, and large-sized annular runways and small-sized annular runways are staggered with each other. A multi-break design is adopted for high-current circuit breakers, in particular generator outlet circuit breakers, in general, multiple sets of vacuum interrupter structures are required be connected in parallel to complete the functions of current passing and breaking, and the annular runway shape design of the heat dissipation fins makes full use of the limited equipment space to increase the heat dissipation area, while also facilitating the installation of the vacuum interrupter and its heat dissipation structures.

In the present disclosure, a central hole 15 runs through the mobile-end heat dissipation structure 1, and in use, the central hole 15 passes through the moving conductive rod 10 at the mobile end 7 of the vacuum interrupter. Further, as shown in FIG. 3A, an end, away from the mobile end 7 of the vacuum interrupter, of the mobile-end heat dissipation structure 1 is provided with a first boss 13, and the first boss 13 is connected to the mobile-end conductive connection structure 3, and the moving conductive rod 10 extends out of the first boss 13, and the first boss 13 can be of any shape, preferably a circular shape, and by taking the circular shape as an example, a diameter of the first boss 13 is about 3-3.5 times a diameter of the central hole 15;

and as shown in FIG. 3B, an end, close to the mobile end 7 of the vacuum interrupter, of the mobile-end heat dissipation structure 1 is provided with a first pit 14.

Preferably, 4-8 screw holes 12, such as 6 screw holes 12, are uniformly distributed in the mobile-end conductive connection structure 3 connected with the first boss 13 and the first pit 14, and the mobile-end heat dissipation structure 1 is fixed to one end of the moving conductive rod 10 through the first boss 13, the first pit 14 and the screw holes 12.

According to the present disclosure, as shown in FIG. 4A, an end, away from the stationary end 8 of the vacuum interrupter, of the stationary-end heat dissipation structure 2 is provided with a second boss 18, the second boss 18 is connected to the stationary-end conductive connection structure 4, and the second boss 18 sleeves an end of the stationary-end conductive block 11; and as shown in FIG. 4B, an end, close to the stationary end 8 of the vacuum interrupter, of the stationary-end heat dissipation structure 2 is provided with a second pit 19.

Preferably, 4-8 screw holes 12, such as 6 screw holes 12, are uniformly distributed in the second boss 18 and the second pit 19, and the stationary-end heat dissipation structure 2 is fixed to one end of the stationary-end conductive block 11 through the second boss 18, the second pit 19 and the screw holes 12.

In the present disclosure, the base material is a metal selected from any one or more of iron, copper, aluminum, tin, nickel, gold, silver, and zinc, preferably copper.

According to the present disclosure, the base material needs to have excellent electrical and thermal conductivity, which is because a high current of tens of kiloamperes to hundreds of kiloamperes needs to pass through the high-current vacuum interrupter, a large temperature rise will be generated during operation, excessive temperature rise will affect the normal operation of the circuit breaker, the mobile-end heat dissipation structure 1 and the stationary-end heat dissipation structure 2 need to be added at both ends of the circuit breaker, and the mobile-end heat dissipation structure 1 and the stationary-end heat dissipation structure 2 should have strong heat dissipation capacity while satisfying the requirement of low resistivity to reduce heat generation. Iron, copper, aluminum, tin, nickel, gold, silver and zinc among the metals all have excellent electrical and thermal conductivity, which can satisfy the actual demands of the base material. Copper is second only to silver in electrical conductivity and second only to gold and silver in thermal conductivity, and also has the characteristics of corrosion resistance, wear resistance, and good plasticity, making it particularly outstanding as an electrically and thermally conductive metal. In view of the fact that the mobile-end conductive connection structure 3 and the stationary-end conductive connection structure 4 are subtractively manufactured on the base material, a material of the mobile-end conductive connection structure 3 and a material of the stationary-end conductive connection structure 4 are consistent with the base material.

In the present disclosure, the base material may be cylindrical, prismatic or cubic, preferably cylindrical, facilitating the processing and manufacturing of the conductive connection structures.

In another aspect, the present disclosure provides a method for manufacturing the heat dissipation device for a vacuum interrupter, including:
Step 1, establishing a structural model of the heat dissipation device;
Step 2, generating a machining procedure from dimensional information of the structural model; and
Step 3, sequentially performing subtractive manufacturing and additive manufacturing on a base material according to the machining procedure to manufacture the heat dissipation device.

The method for manufacturing the heat dissipation device for a vacuum interrupter is described in detail below.

### Step 1, the Structural Model of the Heat Dissipation Device is Established.

According to a preferred embodiment, Step 1 includes the following steps:
Step 1-1, dimensional information of the heat dissipation device is preliminarily determined according to the size of the vacuum interrupter; and
Step 1-2, the structural model of the heat dissipation device is constructed by simulation optimization iteration.

In Step 1-1, as shown in FIGS. 1 (A) to 1 (B), the vacuum interrupter is a vacuum interrupter of a heat dissipation device to be machined, and includes a mobile end 7 of the vacuum interrupter, a stationary end 8 of the vacuum interrupter, a main shield 9, a moving conductive rod 10 and a stationary-end conductive block 11, the mobile end 7 of the vacuum interrupter and the stationary end 8 of the vacuum interrupter are arranged at both ends of the main shield 9, the other end of the mobile end 7 of the vacuum interrupter is provided with the moving conductive rod 10, and the other end of the stationary end 8 of the vacuum interrupter is provided with the stationary-end conductive block 11.

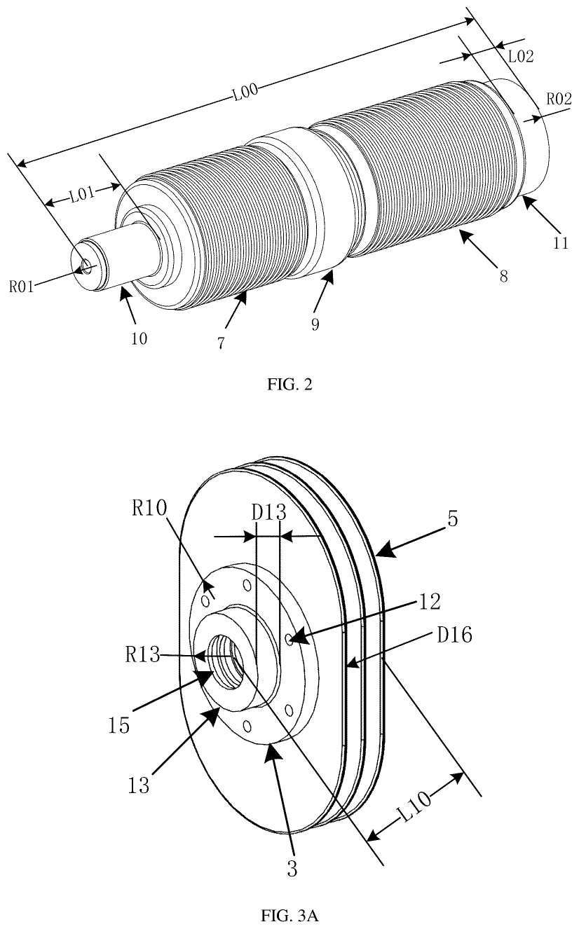

Further, as shown in FIG. 2, the size of the vacuum interrupter includes a length L00 of the vacuum interrupter, a length L01 and a radius R01 of the moving conductive rod 10, and a length L02 and a radius R02 of the stationary-end conductive block 11.

In Step 1-1, the dimensional information of the heat dissipation device includes relevant information of the mobile-end heat dissipation structure 1 and the stationary-end heat dissipation structure 2. Specifically:

As shown in FIG. 3A and FIG. 3B, dimensional information of the mobile-end heat dissipation structure 1 includes a length L10 and a radius R10 of the mobile-end conductive connection structure 3, a radius R11 and a depth D11 of the first pit 14, a radius R12 of the central hole 15, a height D13 and a radius R13 of the first boss 13, and the shape, number N1, pitch D14, thickness D15 and radius R15, and middle length D16 of the mobile-end heat dissipation fins 5.

As shown in FIG. 4A and FIG. 4B, dimensional information of the stationary-end heat dissipation structure 2 includes: a length L20 of the stationary-end conductive connection structure 4, a radius R21 and a depth D21 of the second pit 19, a radius R22 and a height D22 of the second boss 18, and the shape, number N2, pitch D23, thickness D24, radius R24, a middle length D25 of the large annular runway, and a middle length D26 of the small annular runway of the stationary-end heat dissipation fins 6.

In Step 1-1, the dimensional information of the heat dissipation device further includes number, size and specific position information of the screw holes 12. In general, 4-8 screw holes 12, such as 6 screw holes 12, are uniformly distributed in the mobile-end conductive connection structure 3 connected with the first boss 13 and the first pit 14; and 4-8 screw holes 12, such as 6 screw holes 12, are uniformly distributed in the second boss 18 and the second pit 19.

In Step 1-2, the first boss 13, the first pit 14, the central hole 15, the second boss 18, the second pit 19, and the screw holes 12 do not participate in simulation optimization iteration, and the number, shape, and thickness of the mobile-end heat dissipation fins 5 and the number, shape, and thickness of the stationary-end heat dissipation fins 6, and the pitches between the fins are subjected to simulation optimization iteration, and more specifically, the number N1, thickness D15, radius R15 and middle length D16 of the mobile-end heat dissipation fins 5, and the pitch D14 between the mobile-end heat dissipation fins 5, and the number N2, thickness D24, radius R24 and middle length (the middle length D25 of the large annular runway, and the middle length D26 of the small annular runway by taking the condition that the stationary-end heat dissipation fins 6 are in the shape of a large annular runway and a small annular runway as an example) of the stationary-end heat dissipation fins 6, and the pitch D23 between the stationary-end heat dissipation fins 6 are subjected to simulation optimization iteration.

In Step 1-2, the simulation optimization iteration uses Fluent software to perform electromagnetic-thermal coupling simulation, by selecting the number, shape, and size of the mobile-end heat dissipation fins 5 and the stationary-end heat dissipation fins 6, an optimal temperature rise is achieved, and the factors such as the cost, quality, and heat dissipation effect are integrated to specifically determine the above number, shape, and size information.

According to a preferred embodiment, Step 1-2 includes the following sub-steps:
Step 1-2-1, a geometric model is constructed according to the preliminarily determined dimensional information of the heat dissipation device, followed by mesh generation to obtain a geometric model mesh file;
Step 1-2-2, the Fluent software is started, and electromagnetic-thermal coupling simulation is performed on the geometric model mesh file; and
Step 1-2-3, iterative solving is performed, and the geometric model is corrected according to a temperature rise result.

In Step 1-2-1, the number, shape and size of the mobile-end heat dissipation fins 5 and the stationary-end heat dissipation fins 6 are taken as simulation optimization objects, and the remaining sizes of the heat dissipation device are fixed sizes.

In Step 1-2-2, the Fluent software is started, the geometric model mesh file is imported into the Fluent software, an energy model and a fluid model are selected, and an electromagnetic model is defined by a user-defined scalar (UDS), set material physical property parameters are imported, and boundary conditions are defined, and the electromagnetic-thermal coupling simulation is started to be performed.

An electromagnetic field governing equation involved in the electromagnetic model is expressed as follows:

$$\{ \begin{matrix}∇ \times H & = J + \partial D / \partial t \\ ∇ \times E & = - \partial B / \partial t \\ ∇ \cdot B & = 0\end{matrix} \qquad ( 1 )$$

where His a magnetic field intensity vector, J is a current density vector, E is an electric field intensity vector, B is a magnetic induction intensity vector, D is an electric displacement vector, and t is time.

Further, a momentum equation involved in the fluid model is expressed as follows:

$$\frac{\partial ( ρ u )}{\partial t} + ( \frac{\partial ( ρ u \cdot u )}{\partial x} + \frac{\partial ( ρ v \cdot u )}{\partial y} + \frac{\partial ( ρ w \cdot u )}{\partial z} ) = - \frac{\partial ρ}{\partial x} + 2 \frac{\partial }{\partial x} ( μ \frac{\partial u}{\partial x} ) + \frac{\partial }{\partial y} ( μ ( \frac{\partial u}{\partial y} + \frac{\partial v}{\partial x} ) ) + \frac{\partial }{\partial z} ( μ ( \frac{\partial u}{\partial z} + \frac{\partial w}{\partial x} ) ) + ρ g \qquad ( 2 )$$

Further, an energy equation involved in the energy model is expressed as follows:

$$ρ {c}_{ρ} \frac{dT}{dt} = ∇ \cdot ( λ ∇ T ) + {S}_{h} \qquad ( 3 )$$

Further, the simulation also involves a continuity equation, which is expressed as follows:

$$∇ \cdot ( ρ V ) = 0 \qquad ( 4 )$$

in the equations (2) to (4), t is time, ρ is a density, u, v, and w are flow rates in x, y, and z directions, respectively, P is a pressure, μ is a kinetic viscosity, β is an expansion coefficient, T is a temperature, and g is a gravitational acceleration component in an x direction. Cₚ is a specific heat capacity and λ is a thermal conductivity coefficient.

In Step 1-2-2, the boundary conditions are represented by equations (5) to (7), specifically:

When a current passes through the vacuum interrupter, ohmic losses will be generated due to the electric resistance of the metal itself, contact resistance, etc., and an electric energy is converted into a thermal energy, thereby generating a temperature rise. The heat loss generated by current passing is represented by the equation (5),

$$P = \frac{1}{2 σ} {\int }_{V} J \cdot J * dV \qquad ( 5 )$$

where P is a thermal power; and σ is a conductivity.

Heat conduction occurs between objects that are in contact with each other and have different temperatures, and the corresponding equation is expressed as follows:

$$∇ \cdot ( λ ∇ T ) + {S}_{h} = 0 \qquad ( 6 )$$

where λ is a thermal conductivity coefficient and Sₕ is a heat source.

Radiative heat transfer is the transfer of heat between objects by emitting and absorbing radiation, and the corresponding equation is expressed as follows:

$$q = σε ( {T}_{1}^{4} - {T}_{0}^{4} ) \qquad ( 7 )$$

where q is a radiative heat loss, σ is a Stefan-Boltzmann constant, ε is an emissivity, T₁ is an emitter temperature, and T₀ is an acceptor temperature.

In Step 1-2-3, a Couple algorithm is selected for iterative solving, thereby obtaining the temperature rise result, by adjusting the number, pitch, thickness, shape and size of the mobile-end heat dissipation fins 5 and the stationary-end heat dissipation fins 6, optimization simulation is performed, thereby obtaining different temperature rise results, a model in which the temperature rise is smaller and the overall size of the heat dissipation structure is smaller is selected as a final processing and production model.

In Step 1-2-3, an initial temperature is usually set to be 300 K, and an air flow rate is usually set to be 0.

Step 2, the Machining Procedure is Generated from the Dimensional Information of the Structural Model.

In Step 2, the machining procedure includes a machining procedure for the conductive connection structures and a machining procedure for the heat dissipation fins.

Further, the machining procedure for the conductive connection structures includes a machining procedure for the mobile-end conductive connection structure 3 and a machining procedure for the stationary-end conductive connection structure 4; and the machining procedure for the heat dissipation fins includes a machining procedure for the mobile-end heat dissipation fins 5 and a machining procedure for the stationary-end heat dissipation fins 6.

Further, the machining procedure for the conductive connection structures includes machining process, cutting parameter, tool path, and machining path information of the conductive connection structures, and a cutting tool, a cutting speed, and a feeding speed are selected according to the precision and material of the conductive connection structures, and a final NC machining procedure is generated, and introduced into NC machine tool software.

Preferably, the machining process, cutting parameter, tool path, and machining path information, the cutting tool, the cutting speed, and the feeding speed of the mobile-end conductive connection structure 3 and the stationary-end conductive connection structure 4 are kept consistent.

In Step 2, generating the machining procedure for the heat dissipation fins includes the following steps:
Step 2-1, structural models of the mobile-end heat dissipation fins 5 and the stationary-end heat dissipation fins 6 are imported into slicing software to generate a print file; and
Step 2-2, the print file is imported into printing operation software, and processing parameters of the mobile-end heat dissipation fins 5 and the stationary-end heat dissipation fins 6 are set.

In Step 2-1, the structural models of the mobile-end heat dissipation fins 5 and the stationary-end heat dissipation fins 6 are imported into the slicing software, with the axis of the conductive connection structure as a rotating shaft, and with two ends close to the vacuum interrupter as reference surfaces, the layers of slices are all parallel to the reference surfaces, or it is understood that the layers of the slices are all perpendicular to the surface of the base material; and a slice thickness, a melting pitch and a rotation angle between the slices are set. Typically, the slice thickness is set to be 2 mm, the melting pitch is set to be 1.5 mm, and the rotation angle is set to be 0°.

In Step 2-2, as shown in FIG. 5, the processing parameters include processing parameters in a proximal region and processing parameters in a distal region, a region close to the conductive connection structure is referred to as a proximal region 16 of heat dissipation fins, and is typically a circumferential surface which is 25-35 mm, e.g., 30 mm, from the surface of the conductive connection structure, i.e., a circumferential surface which is 25-35 mm, e.g., 30 mm, from the surface of the mobile-end conductive connection structure 3 and a circumferential surface which is 25-35 mm, e.g., 30 mm, from the surface of the stationary-end conductive connection structure 4 belong to the proximal region 16 of the heat dissipation fins.

According to the present disclosure, the proximal region 16 of the heat dissipation fins adopts a large energy deposition strategy, and heat input is high; a region away from the surface of the conductive connection structure is referred to as a distal region 17 of heat dissipation fins, in other words, a region other than the proximal region 16 of the heat dissipation fins is the distal region 17 of the heat dissipation fins, the distal region 17 of the heat dissipation fins adopts a small energy deposition strategy and heat input is low, which is because the proximal region 16 of the heat dissipation fins is closer to the conductive connection structure, the heat conduction is obvious, and the heat is easily dissipated.

Further, processing parameters in the proximal region 16 of the heat dissipation fins include a current input of 290-310 A, a scanning speed of 0.8-1.2 mm/s, and a wire feed speed of 2-3 m/min, such as a current input of 300 A, a scanning speed of 1 mm/s, and a wire feed speed of 2.5 m/min.

Further, processing parameters in the distal region 17 of the heat dissipation fins include a current input of 190-210 A, a scanning speed of 1.8-2.2 mm/s, and a wire feed speed of 2-3 m/min, such as a current input of 200 A, a scanning speed of 2 mm/s, and a wire feed speed of 2.5 m/min.

### Step 3, Subtractive Manufacturing and Additive Manufacturing are Sequentially Performed on the Base Material According to the Machining Procedure to Manufacture the Heat Dissipation Device.

In Step 3, the base material is subjected to subtractive manufacturing based on the machining procedure for the conductive connection structures to obtain the mobile-end conductive connection structure 3 and the stationary-end conductive connection structure 4; and the mobile-end heat dissipation fins 5 and the stationary-end heat dissipation fins 6 are respectively constructed on the surfaces of the mobile-end conductive connection structure 3 and the stationary-end conductive connection structure 4 by additive manufacturing.

In Step 3, prior to additive manufacturing, the positions of an additive manufacturing apparatus and the conductive connection structures, i.e., the mobile-end conductive connection structure 3 and the stationary-end conductive connection structure 4, are calibrated in advance, and the axes of the conductive connection structures, i.e., the mobile-end conductive connection structure 3 and the stationary-end conductive connection structure 4, are positioned at a center position of a rotational axis of the additive manufacturing apparatus.

In Step 3, additive manufacturing is performed based on the processing parameters of the heat dissipation fins.

In Step 3, before additive manufacturing deposition, the conductive connection structures, i.e., the mobile-end conductive connection structure 3 and the stationary-end conductive connection structure 4, which are obtained by subtractive manufacturing are preheated, effectively reducing the difficulty of additive manufacturing deposition of metallic copper and improving the deposition quality. The preheating temperature is 300-500° C., for example, 400° C.

In Step 3, additive manufacturing is first performed according to the processing parameters in the proximal region 16 of the heat dissipation fins, resulting in proximal deposition; and additive manufacturing is then performed according to the processing parameters in the distal region 17 of the heat dissipation fins on the basis of the proximal region 16 of the heat dissipation fins, resulting in distal deposition.

According to a preferred embodiment, the method for manufacturing the heat dissipation device for a vacuum interrupter further includes: Step 4, a secondary machining process, which is used to machine holes in the conductive connection structures and remove impurities on the surfaces of the heat dissipation fins.

Further, the secondary machining process includes:
Step 4-1, the first boss 13, the first pit 14, the central hole 15, the second boss 18, the second pit 19, and the screw holes 12 are processed for installation between the heat dissipation device and the vacuum interrupter; and
Step 4-2, subtractive manufacturing is performed on the heat dissipation fins, which is used to remove rough deposits and impurities on the surfaces of the heat dissipation fins.

According to the present disclosure, by establishing the structural model of the heat dissipation device, and iteratively optimizing the processing parameters of the structural model through simulation, the heat dissipation effect is improved; and by combining subtractive manufacturing with additive manufacturing, the precision of fixing the heat dissipation device to the mobile end 7 of the vacuum interrupter and the stationary end 8 of the vacuum interrupter can be ensured, and the structure of the heat dissipation device can be flexibly designed according to actual needs, significantly reducing the production cost of the heat dissipation device and improving the production and processing efficiency, and the heat dissipation device is used for the vacuum circuit breaker and effectively reducing the temperature rise of the vacuum circuit breaker.

In a third aspect, provided is a vacuum interrupter, including the heat dissipation device in the first aspect.

The heat dissipation device for a vacuum interrupter according to the present disclosure can be applied to a vacuum interrupter with a rated current of 5.5 kA and above.

### Embodiment

The present disclosure is further described below by means of specific examples, but these examples are merely illustrative and do not limit the scope of protection of the present disclosure in any way.

### Embodiment 1

A heat dissipation device for a vacuum interrupter is manufactured according to the following steps;

FIG. 2 shows a vacuum interrupter having a length L00 of 556 mm, a moving conductive rod 10 having a length L01 of 75 mm and a radius R01 of 25 mm, and a stationary-end conductive block 11 having a length L02 of 35 mm and a radius R02 of 60 mm.

(1) According to the size of the vacuum interrupter and empirical values, dimensional information of the heat dissipation device can be preliminarily determined as follows: the mobile-end conductive connection structure 3 has a length L10 of 100 mm, and a radius R10 of 100 mm, and each mobile-end heat dissipation fin 5 is in the shape of an annular runway, the number N1 is 4, the thickness D15 is 5 mm, the fin pitch D14 is 15 mm, the radius R15 is 100 mm, and the middle length D16 is 100 mm; and the stationary-end conductive connection structure 4 has a length L20 of 150 mm, and a radius R22 of 100 mm, and each stationary-end heat dissipation fin 6 is in the shape of an annular runway, the number N2 is 6, the thickness D24 is 5 mm, the fin pitch D23 is 15 mm, and the radius R24 is 100 mm. In order to reduce the mass of the heat dissipation structure, the stationary-end heat dissipation fins are divided into large heat dissipation fins and small heat dissipation fins, the middle length D25 of the large heat dissipation fin is 100 mm, and the middle length D26 of the small heat dissipation fin is 50 mm; and the first pit 14 has a radius R11 of 90 mm and a depth D11 of 20 mm, the central hole 15 has a radius R12 of 30 mm, the first boss 13 has a height D13 of 30 mm and a radius R13 of 50 mm, the second pit 19 has a radius R21 of 80 mm and a depth D21 of 45 mm, the second boss 18 has a radius R22 of 67.5 mm and a height D22 of 20 mm, and 6 screw holes 12 are uniformly distributed in the mobile-end conductive connection structure 3 connected with the first boss 13, the first pit 14, the second boss 18 and the second pit 19.

Next, Fluent software is adopted to perform electromagnetic-thermal coupling simulation, and by selecting the number, shape, and size of the mobile-end heat dissipation fins 5 and the stationary-end heat dissipation fins 6, an optimal temperature rise is achieved, and the factors such as the cost, quality, and heat dissipation effect are integrated to determine optimized number, shape, and size information of the mobile-end heat dissipation fins 5 and the stationary-end heat dissipation fins 6. The specific steps are as follows:
first, a geometric model is constructed according to the preliminarily determined dimensional information of the heat dissipation device, followed by mesh generation to obtain a geometric model mesh file, wherein by taking the number, shape and size of the mobile-end heat dissipation fins 5 and the stationary-end heat dissipation fins 6 as simulation optimization objects, an air domain of 700 mm*700 mm*700 mm is set around the geometric model;
next, the Fluent software is started to perform electromagnetic-thermal coupling simulation, the geometric model mesh file is imported into the Fluent software, an energy model, a flow model SST k-omega, and an electromagnetic model are opened, air physical property parameters and physical property parameters of copper, a material used by the heat dissipation device, are imported, and boundary conditions are set; and
a Couple algorithm is then selected, the initial temperature is set to be 300 K, an air flow rate is set to be 0, and the temperature rise result is obtained accordingly, the number, the pitch, the thickness, the shape and the size of the mobile-end heat dissipation fins 5 and the stationary-end heat dissipation fins 6 are adjusted, simulation is performed again, and according to the simulation optimization result, final optimization model parameters are as follow:
each mobile-end heat dissipation fin 5 is in the shape of an annular runway, the number N1 is 3, the thickness D15 is 5 mm, the fin pitch D14 is 25 mm, the radius R15 is 125 mm, and the middle length D16 is 120 mm; and each stationary-end heat dissipation fin 6 is in the shape of an annular runway, the number N2 is 6, the thickness D24 is 5 mm, the fin pitch D23 is 25 mm, the radius R24 is 125 mm, the middle length D25 of the large heat dissipation fin is 120 mm, and the middle length D26 of the small heat dissipation fin is 70 mm.

(2) A numerical control program is written according to the structural model of the heat dissipation device established in Step (1), and parameters such as a machining path, a machining speed, and a machining depth of a machine tool are determined; and the numerical control program is loaded into the machine tool, and a cutting speed, a feeding speed, and tool selection of the machine tool are set; and
structural models of the mobile-end heat dissipation fins 5 and the stationary-end heat dissipation fins 6 are imported into slicing software, with the axes of the mobile-end conductive connection structure 3 and the stationary-end conductive connection structure 4 as rotating shafts, and with two ends close to the vacuum interrupter as reference surfaces, the layers of slices are all parallel to the reference surfaces, a slice thickness is set to be 2 mm, a melting pitch is set to be 1.5 mm, a rotation angle is set to be 0°, and a circumferential surface which is 30 mm from the surface of the mobile-end conductive connection structure 3 and a circumferential surface which is 30 mm from the surface of the stationary-end conductive connection structure 4 are set to be the proximal region 16 of the heat dissipation fins, a current input is set to be 300 A, a scanning speed is set to be 1 mm/s, and a wire feed speed is set to be 2.5 m/min; and a region other than the proximal region 16 of the heat dissipation fins is referred to as the distal region 17 of the heat dissipation fins, a current input is set to be 200 A, a scanning speed is set to be 2 mm/s, and the wire feed speed is set to be 2.5 m/min.

(3) A base material is fixed to a machining position, a tool is mounted, and subtractive manufacturing is performed on the base material according to the parameters in Step (2) to obtain the mobile-end conductive connection structure 3 and the stationary-end conductive connection structure 4; then the axes of the mobile-end conductive connection structure 3 and the stationary-end conductive connection structure 4 are positioned at a center position of a rotational axis of an additive manufacturing apparatus, the base material obtained after subtractive manufacturing is preheated to 400° C., the mobile-end heat dissipation fins 5 and the stationary-end heat dissipation fins 6 are respectively constructed on the surfaces of the mobile-end conductive connection structure 3 and the stationary-end conductive connection structure 4 by additive manufacturing, and as shown in FIG. 5, additive manufacturing is performed according to processing parameters in the proximal region 16 of the heat dissipation fins, resulting in proximal deposition; and additive manufacturing is then performed according to processing parameters in the distal region 17 of the heat dissipation fins on the basis of the proximal deposition, resulting in distal deposition.

(4) As shown in FIG. 1A, FIG. 1B, FIG. 3A, FIG. 3B, FIG. 4A and FIG. 4B, the first boss 13, the first pit 14, the central hole 15, the second boss 18, the second pit 19, and the screw holes 12 are machined, and the mobile-end heat dissipation fins 5 and the stationary-end heat dissipation fins 6 are subtractively manufactured.

The present disclosure has been described in detail above with reference to preferred embodiments and illustrative examples. However, it should be noted that these specific embodiments are merely illustrative of the present disclosure and do not limit the scope of protection of the present invention in any way. Various modifications, equivalent replacements or modifications can be made to the technical contents and the embodiments of the present disclosure without departing from the spirit and protection scope of the present disclosure, which all fall within the protection scope of the present disclosure. The scope of protection of the present disclosure is subject to the appended claims.

1. A heat dissipation device for a vacuum interrupter, comprising a mobile-end heat dissipation structure (1) and a stationary-end heat dissipation structure (2) which are disposed at two ends of the vacuum interrupter, wherein the heat dissipation device is manufactured by a method of combining additive manufacturing with subtractive manufacturing.

2. The heat dissipation device according to claim 1, wherein preferably, a length of the stationary-end heat dissipation structure (2) is 1.5-3 times a length of the mobile-end heat dissipation structure (1).

3. The heat dissipation device according to claim 1, wherein the mobile-end heat dissipation structure (1) comprises a mobile-end conductive connection structure (3) and mobile-end heat dissipation fins (5), and the mobile-end heat dissipation fins (5) are disposed on a surface of the mobile-end conductive connection structure (3).

4. The heat dissipation device according to claim 3, wherein the mobile-end heat dissipation fins (5) are perpendicular to a cross section of the mobile-end conductive connection (3).

5. The heat dissipation device according to claim 3, wherein the mobile-end conductive connection structure (3) is connected with a moving conductive rod (10) at a mobile end (7) of the vacuum interrupter.

6. The heat dissipation device according to claim 1, wherein the stationary-end heat dissipation structure (2) comprises a stationary-end conductive connection structure (4) and stationary-end heat dissipation fins (6), and the stationary-end heat dissipation fins (6) are disposed on a surface of the stationary-end conductive connection structure (4).

7. The heat dissipation device according to claim 6, wherein the stationary-end heat dissipation fins (6) are perpendicular to a cross section of the stationary-end conductive connection structure (4).

8. The heat dissipation device according to claim 6, wherein the stationary-end conductive connection structure (4) is connected with a stationary-end conductive block (11) at a stationary end (8) of the vacuum interrupter.

9. A method for manufacturing the heat dissipation device according to claim 1, comprising:
Step 1, establishing a structural model of the heat dissipation device;
Step 2, generating a machining procedure from dimensional information of the structural model; and
Step 3, sequentially performing subtractive manufacturing and additive manufacturing on a base material according to the machining procedure to manufacture the heat dissipation device.

10. A vacuum interrupter, comprising the heat dissipation device according to claim 1.

11. The method of claim 9, wherein preferably, a length of the stationary-end heat dissipation structure (2) is 1.5-3 times a length of the mobile-end heat dissipation structure (1).

12. The method of claim 9, wherein the mobile-end heat dissipation structure (1) comprises a mobile-end conductive connection structure (3) and mobile-end heat dissipation fins (5), and the mobile-end heat dissipation fins (5) are disposed on a surface of the mobile-end conductive connection structure (3).

13. The method of claim 12, wherein the mobile-end heat dissipation fins (5) are perpendicular to a cross section of the mobile-end conductive connection (3).

14. The method of claim 12, wherein the mobile-end conductive connection structure (3) is connected with a moving conductive rod (10) at a mobile end (7) of the vacuum interrupter.

15. The method of claim 9, wherein the stationary-end heat dissipation structure (2) comprises a stationary-end conductive connection structure (4) and stationary-end heat dissipation fins (6), and the stationary-end heat dissipation fins (6) are disposed on a surface of the stationary-end conductive connection structure (4).

16. The method of claim 15, wherein the stationary-end heat dissipation fins (6) are perpendicular to a cross section of the stationary-end conductive connection structure (4).

17. The method of claim 15, wherein the stationary-end conductive connection structure (4) is connected with a stationary-end conductive block (11) at a stationary end (8) of the vacuum interrupter.

18. The vacuum interrupter of claim 10, wherein preferably, a length of the stationary-end heat dissipation structure (2) is 1.5-3 times a length of the mobile-end heat dissipation structure (1).

19. The vacuum interrupter of claim 10, wherein the mobile-end heat dissipation structure (1) comprises a mobile-end conductive connection structure (3) and mobile-end heat dissipation fins (5), and the mobile-end heat dissipation fins (5) are disposed on a surface of the mobile-end conductive connection structure (3).

20. The vacuum interrupter of claim 19, wherein the mobile-end heat dissipation fins (5) are perpendicular to a cross section of the mobile-end conductive connection (3).
